(19) United States
(12) Patent Application Publication
(10) Pub. No.: US 2005/0108837 A1
(43) Pub. Date: May 26, 2005

(54) Holder for a tool to be supplied with a fluid and a tool which is to be supplied with a fluid

(75) Inventor: Norbert Klinkhammer, Roetgen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Duerr Ecoclean GmbH, Filderstadt (DE)

(21) Appl. No.: 10/970,298

(22) Filed: Oct. 21, 2004

Related U.S. Application Data
(63) Continuation of application No. PCT/EP03/10831, filed on Sep. 30, 2003.

(30) Foreign Application Priority Data
Oct. 25, 2002 (DE) 102 49 708.7

(51) Int. Cl. A01K 43/00

(52) U.S. Cl. 15/3.14; 15/320

(57) ABSTRACT

In order to provide a holder for a tool, in particular a water tool, to be supplied with a fluid, which holder allows the tool to be held in the holder to be connected simply, quickly and reliably to the holder, it is proposed that the holder comprises a receiver for receiving a connection piece of the tool, a sealing element which engages the connection piece in a working position, and a biasing device for biasing the sealing element against the connection piece in the working position.

This application is a continuation application of PCT/EP2003/10831 filed Sep. 30, 2003, and claiming priority to German application 102 49 708.7 filed Oct. 25, 2002. The entire specifications of both applications are incorporated herein by reference.

### FIELD OF THE INVENTION

The present invention relates to a holder for a tool, in particular a water tool, to be supplied with a fluid. The present invention also relates to a tool, in particular a water tool, to be held in a holder of this type and to be supplied with a fluid.

### BACKGROUND OF THE INVENTION

Tools of this type, in particular water tools, to be supplied with a fluid, can be designed, for example, as spray lances which are provided with a discharge nozzle for the discharge of the fluid fed and may be used, for example, to debur and/or clean tools onto which the fluid jet leaving the discharge nozzle is directed.

In particular, the present invention relates to tools of the type to which the fluid is fed at a high pressure of at least 100 bar, preferably at least 1,000 bar. A particularly good de-burring and cleaning effect can be achieved with super-pressure fluid tools of this type.

Known super-pressure fluid tools of the aforementioned type are connected by screwing to the tool holder which is connected to the fluid feed line. In the process, a thrust collar and pressure screw or shell with a union nut can be used, for example.

In a holder to which the fluid tool has to be screwed, a suitable connecting tool, for example a spanner, is required to produce the connection between the tool and the holder. Moreover, the tool has to be screwed with great care as the holder of the fluid tool is often arranged on sensitive expensive components, such as, for example, rotary operating mechanisms or robots.

### OBJECTS AND BRIEF SUMMARY OF THE INVENTION

The present invention is therefore based on the object of providing a holder for a tool, in particular a water tool, to be supplied with a fluid, which holder allows the tool to be held in the holder to be connected simply, quickly and reliably to the holder.

This object is achieved according to the invention in a holder with the features of the preamble of claim 1, in that the holder comprises a receiver for receiving a connection piece of the tool, a sealing element which abuts the connection piece in a working position, and a biasing device for biasing the sealing element against the connection piece in the working position.

The solution according to the invention allows a reliably sealing connection to be produced between the holder and the tool without it being necessary to screw the tool to the holder.

The connection between the tool and the holder according to the invention can be produced manually without a connecting tool being necessary.

Because the screwing of the tool to the holder has been dispensed with, no mechanical loading of the tool or the component on which the holder is arranged occurs either.

Owing to the solution according to the invention, a holder with a quick-release lock which can be released manually is provided, which is also suitable, in particular, for super-pressure fluid tools, to which the fluid is fed at a high pressure of at least 100 bar, preferably at least 1,000 bar.

The holder according to the invention can then be rotated, in particular during operation of the tool, about its longitudinal axis during operation of the tool and then transmits to the tool the torque required for rotating the tool.

In this case, the tool may, for example, be provided with a milling head which is set into rotation by the rotation of the tool itself.

The connection piece can be designed integrally with an operating part of the tool or else designed as a separate part.

In the holder according to the invention, it may be provided, in particular, that the receiver is designed such that the connection piece is secured against moving out of the holder in the working position.

It may also be provided that the receiver is designed such that the connection piece is secured in the working position against rotation of the connection piece about its longitudinal axis relative to the holder. The rotary movement can then thereby be transmitted from the holder to the tool, in particular when the holder is rotatably arranged or arranged on a rotary component.

It may, in particular, be provided that the connection piece can be inserted into the holder in an insertion position and, after insertion into the holder, can be brought into the working position by rotation about its longitudinal axis, optionally with a subsequent translatory movement, in which working position the connection piece is secured against a rotation of the connection piece about its longitudinal axis and against moving out of the holder.

The biasing device, which biases the sealing element of the holder against the connection piece, may, in particular, comprise a spring element.

The sealing element is preferably displaceably guided in the holder.

It may, in particular, be provided, that the sealing element can be substantially linearly displaced from a rest position into its working position in which the sealing element abuts the connection piece of the tool.

In order to produce a fluid-tight connection between the holder and the tool, it may be provided that the sealing element has a sealing face which in the working position abuts a sealing face of the connection piece.

In a preferred embodiment of the holder according to the invention it is provided that the sealing face of the sealing element is substantially truncated cone-shaped in design.

Owing to the truncated cone-shaped design of the sealing face, a particularly reliable sealing effect is produced and it is also ensured that the sealing element can easily be detached from the connection piece if the connection piece and/or the sealing element are to be permanently shaped on insertion or during operation of the tool.

It has proven to be particularly advantageous if the sealing face of the sealing element has a cone aperture angle of about 40° to about 80°, preferably about 50° to about 70°. The cone aperture angle is to be taken to mean here twice the angle enclosed by the lateral surfaces of the cone with the cone axis.

In a particular embodiment of the holder according to the invention, it is provided that the sealing element has a fluid through-channel, through which the fluid to be fed to the tool can flow.

In order to achieve a particularly high pressing force of the sealing element against the connection piece of the tool, it may be provided that the sealing element has a pressure face which can be loaded by the fluid to be fed to the tool.

In this case it is particularly favourable if the projection of the pressure face of the sealing element onto a plane perpendicular to the direction of displacement of the sealing element is greater than the projection of a sealing face of the sealing element, with which the sealing element abuts a sealing face of the connection piece in the working position, onto a plane which is perpendicular to the direction of displacement of the sealing element.

In order to achieve a pressing force of the sealing element which is as high as possible, during operation of the tool, it is advantageously provided that the projection of the pressure face of the sealing element is at least twice, preferably at least three times, as great as the projection of the sealing face of the sealing element on to a plane which is perpendicular to the direction of displacement of the sealing element.

In order to be able to detach the sealing element from the connection piece of the tool simply and quickly, it is advantageous if the holder comprises a movement device for moving the sealing element from the working position into a rest position, in which the sealing element does not abut the connection piece.

A movement device of this type may, in particular, comprise a relief nut.

A particularly high pressing force of the sealing element against the connection piece and therefore a particular good sealing effect during the operation of the fluid tool can be achieved if the sealing element can be loaded with a fluid at a pressure of at least 100 bar, preferably at least 1,000 bar.

The present invention is based on the further object of providing a tool, in particular a water tool, to be supplied with a fluid, which tool can be connected easily, quickly and reliably to a holder for the tool.

This object is achieved by a tool, in particular a water tool, to be supplied with a fluid, which tool can be inserted into the receiver of a holder according to the invention according to any one of claims 1 to 15, can be brought into a working position in the holder and can be brought into contact with the sealing element of the holder in the working position.

In a preferred embodiment of the tool according to the invention, it is provided that the tool has a sealing face with which the tool abuts a sealing face of the sealing element of the holder in the working position.

It has proven to be particularly advantageous if the sealing face of the tool is substantially truncated cone-shape in design. A particularly good sealing effect is thereby achieved between the sealing faces of the sealing element, on the one hand, and the tool, on the other hand. It is also ensured by this design of the sealing face that the tool can then also be easily detached from the sealing element of the holder if the tool and/or the sealing element of the holder are to be permanently shaped on insertion or during operation of the tool.

It is particularly advantageous if the sealing face of the tool has a cone aperture angle of about 40° to about 80°, preferably of about 50° to about 70°. The cone aperture angle is here taken to mean twice the angle which the lateral surfaces of the cone enclose with the cone axis.

In a preferred embodiment of the tool according to the invention it is provided that the sealing face is arranged on a substantially truncated cone-shaped end region of the tool.

In order to be able to insert the tool particularly easily into the holder and remove it again from the holder, it is provided in a preferred embodiment of the tool according to the invention that the tool has a first substantially cylindrical section with a first diameter and a second substantially cylindrical section with a second diameter, the first cylindrical section being arranged between the second cylindrical section and the substantially truncated cone-shaped end region of the tool and the second diameter being greater than the first diameter.

In order to achieve a secure hold of the tool in the holder, it may be provided that the tool comprises a non-rotationally symmetrical collar which, in the working position, prevents a movement of the connection piece of the tool out of the holder in the longitudinal direction of the connection piece.

It is also preferably provided that the tool comprises a non-rotationally symmetrical collar which, in the working position, prevents a rotation of the connection piece about its longitudinal axis relative to the holder. The rotary movement can thereby be transmitted from the holder to the tool, in particular when the holder is rotatably arranged or arranged on a rotary component.

Preferably, at least one contact face of the collar of the tool engages a contact face of the holder in such a way that a torque can be transmitted from the holder to the tool.

It may in particular be provided that the tool is designed such that it can be inserted into the holder in an insertion position and, inside the holder, can be brought into the working position by a rotation about an angle of, for example, 90° about the longitudinal axis of the tool and optionally a translatory movement of the tool.

Claim 24 is directed at a combination of a holder according to the invention and a tool according to the invention.

Further features and advantages of the invention are the subject of the following description and the graphical representation of an embodiment.

### BRIEF DESCRIPTION OF THE DRAWINGS

FIG. 1 shows a schematic section through a holder for a tool to be supplied with a fluid, a connection piece of the tool being received in the holder in a working position;

FIG. 2 shows a schematic cross-section through the holder and the tool from FIG. 1, along the line 2-2 in FIG. 1;

FIG. 3 shows a schematic cross-section through the holder and the tool from FIG. 1, along the line 3-3 in FIG. 1;

FIG. 4 shows a schematic cross-section corresponding to FIG. 3 through the holder and the tool, the tool being located in an insertion position;

FIG. 5 shows a schematic cross-section through the holder from FIG. 1 with the tool removed;

FIG. 6 shows a schematic cross-section through the tool from FIG. 1;

FIG. 7 shows a schematic longitudinal section through a holding claw of the holder from FIG. 1;

FIG. 8 shows a schematic cross-section through the holding claw from FIG. 7 along the line 8-8 in FIG. 7; and

FIG. 9 shows a schematic plan view from below onto the holding claw from FIG. 7, with the viewing direction in the direction of arrow 9 in FIG. 7.

### DETAILED DESCRIPTION OF VARIOUS EMBODIMENTS

Identical or functionally equivalent elements are shown in the drawings with the same reference numerals.

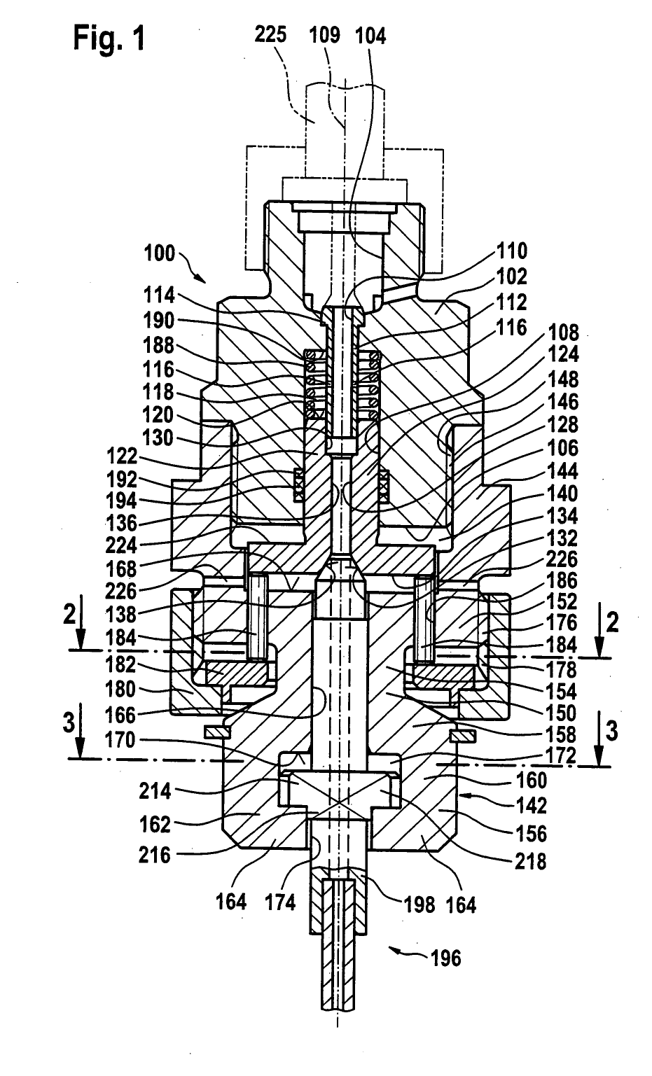

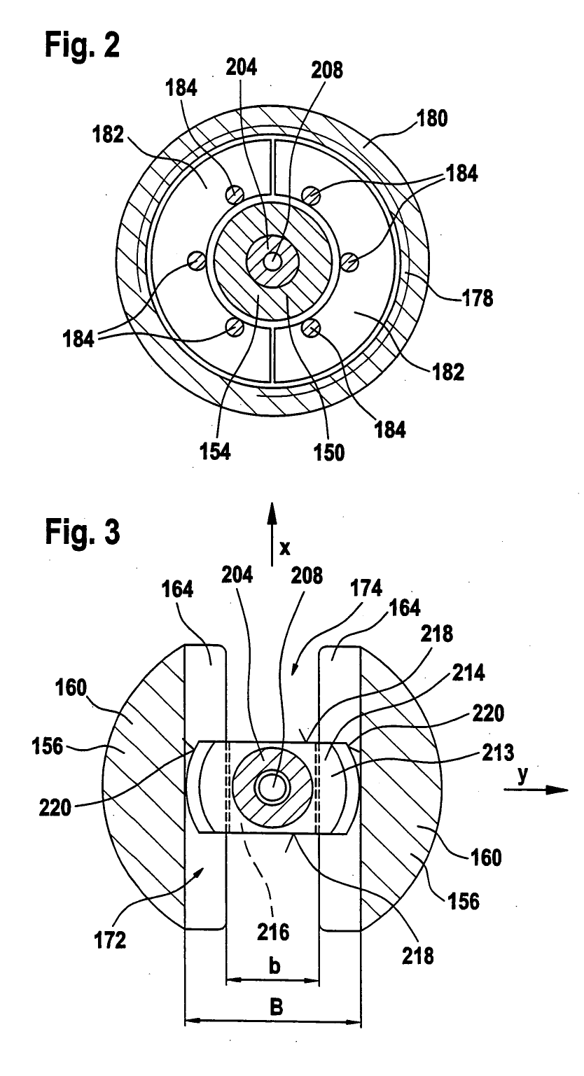

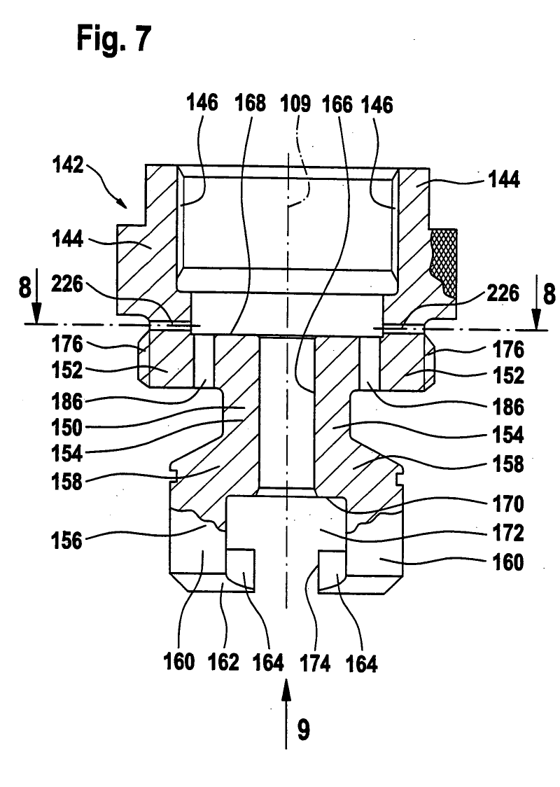

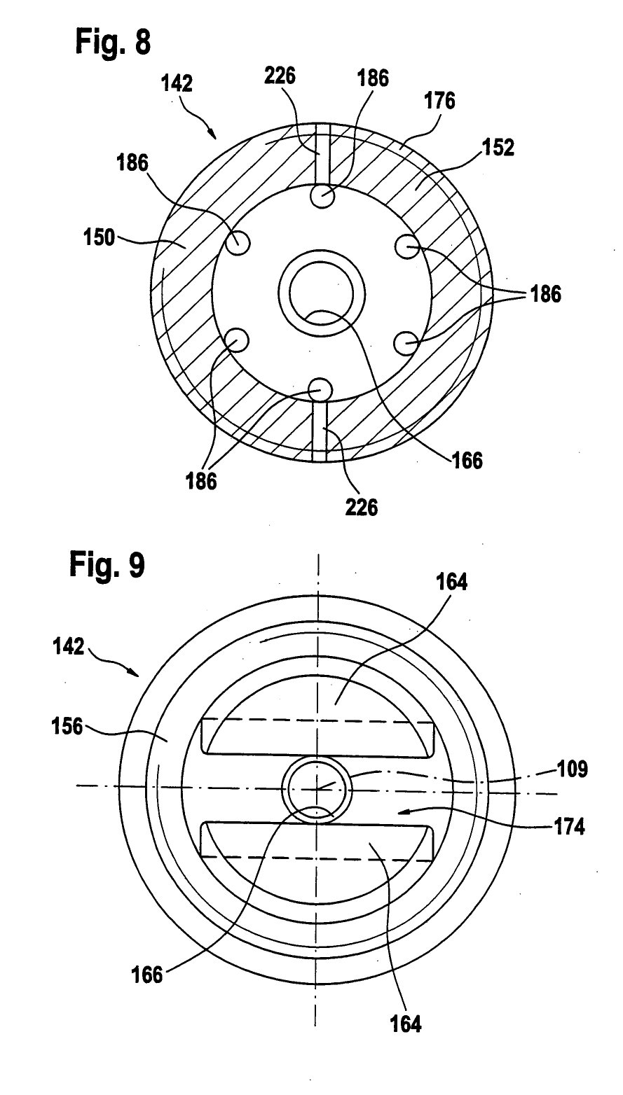

A holder shown in FIGS. 1 to 5 and 7 to 9 and designated as a whole by 100, for a tool, in particular a water tool, to be supplied with a fluid, comprises a pressure cylinder 102, which is provided at its upper end on the connection side with a stepped, axial connection hole 104. A central, axial guide hole 108 extends upwardly along the longitudinal axis 109 of the holder 100 from the lower end face 106 of the pressure cylinder 102. The upper connection hole 104 and the lower guide hole 108 are connected to one another via a stepped, axial connection hole 110.

Fitted into the connection hole 110 is a hollow cylindrical sleeve 112 which is provided, at its upper end, with a collar 114 projecting in the radial direction, the lower side of which abuts the step of the stepped connection hole 110, so the sleeve 112 cannot move downwardly through the connection hole 110 into the guide hole 108.

A lower section of the sleeve 112 projecting into the guide hole 108 is provided with radial through apertures 116, via which the interior of the sleeve 112 is connected to the region of the guide hole 108 which is located outside the sleeve 112 and forms a pressure chamber 118.

The pressure chamber 118 is delimited at the bottom by the upper end face 120 of a sealing piston 122 which has an upper, cylindrical guide section 124 guided so as to be displaceable in a sliding manner in the axial direction in the guide hole 108, and a cylindrical end plate 126 which at the bottom adjoins the guide section 124 and has a substantially larger diameter than the guide section 124 and is designed integrally therewith.

The sealing piston 122 has a central, axial fluid through-channel 128 which comprises a cylindrical inlet section 130 opening at the upper end face 120 of the sealing piston 122, a conical discharge section 132 opening at the lower end face 134 of the sealing piston 122 and widening towards it, and a cylindrical connecting section 136 connecting the inlet section 130 to the discharge section 132, the diameter of which connecting section 136 is smaller than the diameter of the cylindrical inlet section 130 and corresponds to the smallest diameter of the conical discharge section 132.

The lateral delimiting face of the conical discharge section 132 forms a substantially truncated cone-shaped sealing face 138 of the sealing piston 122.

The cone aperture angle of the sealing face 138 is preferably about 60°.

The lower end of the sleeve 112 is received in the entry section 130 of the fluid through-channel 128, so the connection hole 104 is connected to the fluid through-channel 128 via the sleeve 112.

The lower end of the sealing piston 122 with the end plate 126 projects into a connection chamber 140 which is delimited, on the one hand, by the lower end face 106 of the pressure cylinder 102 and, on the other hand, by an inner delimiting wall of a holding claw 142 which has a substantially hollow cylindrical connecting section 144 with an internal thread 146 which is screwed into an external thread 148 on the lower end of the pressure cylinder 102 for connection to the pressure cylinder 102.

A guide section 150 with an upper cylindrical part section 152 and a central cylindrical part section 154 at the bottom adjoins the connecting section 144 of the holding claw 142, the central part section 154 having a substantially smaller diameter than the upper part section 152. A lower part section 158 of the guide section 150, which widens conically downwardly, at the bottom adjoins the central part section 154.

A holding section, designated by 156 as a whole, which comprises a substantially cylindrical upper part section 160 and a lower part section 162 formed by two opposing retaining projections 164 at the bottom adjoins the lower part section 158 of the guide section 150 of the holding claw 142.

All the above-mentioned elements of the holding claw 142 are designed integrally with one another.

The guide section 150 and the upper part section 158 of the holding claw 142 are penetrated by a cylindrical, axial tool guide channel 166 which opens, on the one hand, at the upper end face 168 of the guide section 150 into the connection chamber 140 and, on the other hand, at the upper end face 170 of the guide section 150 into a receiving chamber 172 formed in the holding section 156 of the holding claw 142.

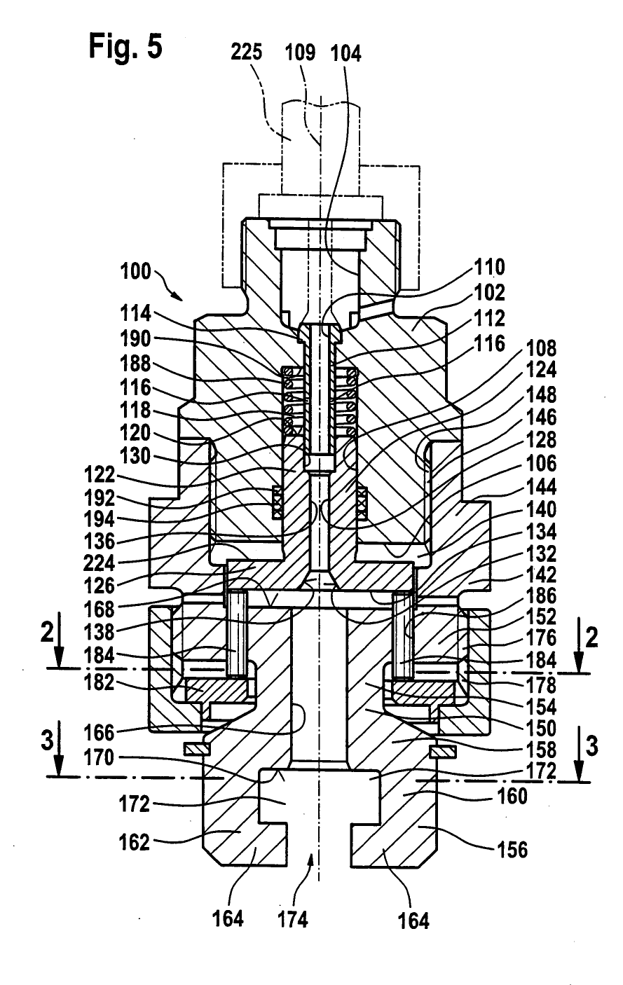

As can be best seen from FIGS. 3 and 5, the receiving chamber 172 has a substantially rectangular cross-section and extends, in an x-direction perpendicular to the axial direction 109 of the holder 100 through the entire holding section 156.

The receiving chamber 172 is delimited on the side opposing the tool guide channel 166 by the retaining projections 164, between which is formed a tool insertion channel 174 which is oriented parallel to the receiving chamber 172 (i.e. along the x-direction) but has a width b (perpendicular to the x-direction) which is smaller than the width B of the receiving chamber 172.

As can best be seen from FIG. 5, the upper part section 152 of the guide section 150 of the holding claw 142 has, at its outer periphery, an external thread 176 on which a relief nut 180 provided with an internal thread 178 is screwed from below.

Received in the interior of the relief nut is a split ring 182 which annularly surrounds the central part section 154 of the guide section 150 and is supported at the bottom on the relief nut 180.

The ring 182 is in contact with the lower end face 134 of the sealing piston 122 via a plurality of, for example six, spacer pins 184 which extend through a respective axial through-hole 186 in the upper part section 152 of the guide section 150.

Arranged in the pressure chamber 118 of the pressure cylinder 102 is a helical spring 188 which surrounds the sleeve 112 and is supported, on the one hand, on the upper limiting wall 190 of the pressure chamber 118 and, on the other hand, on the upper end face 120 of the sealing piston 122.

The sealing piston 122 is biased downwards in the axial direction by this helical spring 188.

By screwing the relief nut 180 onto the external thread 176 of the guide section 150 of the holding claw 142, whereby the relief nut 180 moves upwardly, the sealing piston 122, supported via the spacer pins 184 and the ring 182 on the relief nut 180, can be moved upwardly in the axial direction against the spring force of the helical spring 188.

The guide hole 108 of the pressure cylinder 102, in which the sealing piston 122 is displaceably guided in the axial direction, is provided with an annular groove 192 in which is arranged a sealing ring 194. The sealing ring 194 lies, on the one hand, on the pressure cylinder 102 and, on the other hand, on the outer periphery of the guide section 124 of the sealing piston 122 and thus prevents fluid from the pressure chamber 118 passing along the outside of the sealing piston 122 into the connection chamber 140.

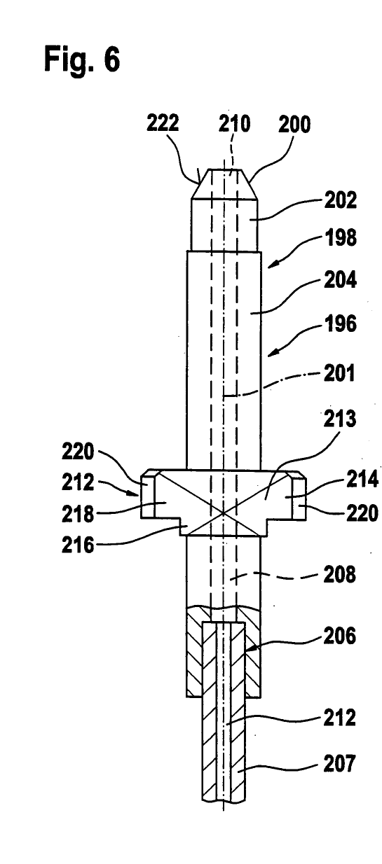

The tool 196 to be held in the holder 100 described above is shown in particular in FIG. 6.

The tool 196 comprises a tool connection piece, designated as a whole by 198, comprising a conical sealing section 200, a first cylindrical section 202 adjoining the sealing section 200 in the axial direction 201 of the connection piece 198 and a second cylindrical section 204 adjoining the first cylindrical section in the axial direction 201 of the connection piece 198.

The external diameter of the second cylindrical section 204 of the tool connection piece 198 is slightly smaller than the diameter of the tool guide channel 166 of the holding claw 142, so the tool connection piece 198, after insertion thereof into the holding claw 142 is guided so as to be displaceable in a sliding manner in the tool guide channel 166.

The external diameter of the first cylindrical section 202 of the tool connection piece 198 is somewhat smaller than the external diameter of the second cylindrical section 204.

A receiver 206 for a connection end of an operating part 207 (only shown in sections) of the tool 196 is provided on the end of the second cylindrical section 204 remote from the sealing section 200.

A fluid through-channel 208 penetrating the tool connection piece 198 in the axial direction opens into the receiver 206. The fluid to be fed to the tool 196 can arrive via this fluid through-channel 208 from an inlet aperture 210 provided on the sealing section 200 to the receiver 206, where it enters into a fluid through-channel 212 provided in the operating part 207 and can be fed from there for its use in the tool.

It may, in particular, be provided that the tool 196 is designed as a high pressure spray lance comprising a lance point (not shown) with an outlet nozzle through which the fluid fed to the tool 196, in particular water, discharges at high pressure and can be used to de-bur and/or clean a tool.

Also provided on the second cylindrical section 204 of the tool connection piece 198 is a collar 213 projecting in the radial direction which comprises a contact section 214 facing the sealing section 200 and an anti-rotation section 216 facing the receiver 206 for the operating part 207.

The anti-rotation section 216 has a right parallelepiped shape with a square cross-section. The edge length of the anti-rotation section 216 is slightly smaller than the width b of the tool insertion channel 174 of the holding claw 142.

The anti-rotation section 216 has the shape of a two-faced portion with two opposing flat delimiting faces 218 (see for example FIG. 3) which are connected to one another via two opposing delimiting faces 220 which are bent in a segment of a circle shape. The spacing between the flat delimiting faces 218 which are aligned parallel to one another corresponds to the edge length of the anti-rotation section 216.

The largest extent of the contact section 214 parallel to the flat delimiting faces 218 is slightly smaller than the width B of the receiving chamber 172 of the holding claw 142.

The substantially truncated cone-shaped peripheral face of the conical sealing section 200 of the tool connection piece 198 forms a sealing face 222.

The cone aperture angle of the sealing face 222 of the tool connection piece 198 is somewhat smaller than the cone aperture angle of the sealing face 138 of the sealing piston 122, preferably smaller by about 2°, and is, for example, about 58°.

The holder 100 described above for holding the tool 196 operates as follows:

In order to insert the tool 196 into the holder 100, the sealing piston 122 is firstly moved from the working position shown in FIG. 5 into a rest position in which the upper side 224 of the end plate 126 abuts the lower end face 106 of the pressure cylinder 102 while the relief nut 180 is screwed to a corresponding extent onto the external thread 176 of the guide section 150 of the holding claw 142 and the sealing piston 122 is thus pressed upwardly in the axial direction against the spring force of the helical spring 188.

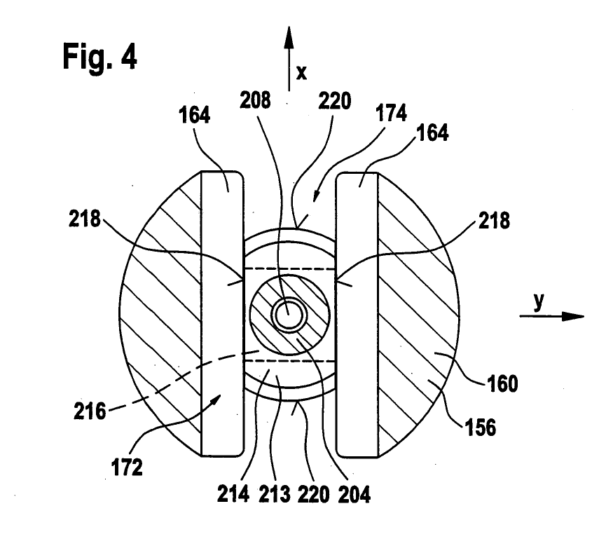

The tool 196 with the tool connection piece 198 in front in the orientation shown in FIG. 4, in which the flat delimiting faces 218 of the contact section 214 are oriented parallel to the x-direction of the holder 100 is then inserted through the tool insertion channel 174 and the tool guide channel 150 into the connection chamber 140 until the contact section 214 of the tool connection piece 198 strikes the lower end face of the guide section 150 of the holding claw 142.

The tool connection piece 198 is then rotated about its longitudinal axis 201 about an angle of 90° and moved back in the direction of the longitudinal axis 201 until the anti-rotation section 216 comes to rest between the retaining projections 164 of the holding claw 142 and the contact section 214 abuts the retaining projections 164.

The relief nut 180 is now rotated out of the external thread 176 of the guide section 150 of the holding claw 142 and therefore moved downwardly in the axial direction until the sealing piston 122, which is moved by the spring force of the helical spring 188 downwardly in the axial direction to the sealing section 200 of the tool connection piece 198, engages with its conical sealing face 138 on the likewise conical sealing face 222 of the tool connection piece 198.

In this position, the tool connection piece 198 is pressed against the retaining projections 164 with its contact section 214 by the restoring force of the helical spring 188 transmitted by the sealing piston 122 to the sealing section 200, with the result that the tool connection piece 198 is fixed in its axial position relative to the holding claw 142.

As the anti-rotation section 216 in this position rests with two of its delimiting faces on lateral delimiting faces of the retaining projections 164, the tool connection piece 198 is also secured in this position against rotation about its longitudinal axis.

The combination of holder 100 and tool 196 is ready for operation in this state.

The holder 100, at its upper end, is connected to a fluid feed line 225 (shown by broken lines in FIGS. 1 and 5), by means of which a fluid, for example water with or without additives, can be fed to the connection hole 104 of the holder 100, at a high pressure of, for example, 1,500 bar.

After opening of the fluid feed line, the fluid, which is under high pressure, arrives through the sleeve 112 and the radial through-apertures 116 in its casing into the pressure chamber 118 of the pressure cylinder 102, so the upper end face 120 of the sealing piston 122 is loaded by the fluid with the high pressure.

The sealing piston 122 is thereby pressed in the axial direction against the sealing section 200 of the tool connection piece 198, wherein the resulting pressing force depends on the ratio of the projection of the face of the upper end face 120 of the sealing piston 122 to the projection of the face on which the sealing piston 122 and the sealing section 200 abut one another, onto a plane perpendicular to the axial direction of the holder 100.

The sealing piston 122 and the tool connection piece 198 consist of a metallic material, so the sealing faces 138 and 222 pressed against one another are sealed from one another metallically.

The fluid to be fed to the tool 196 therefore passes from the fluid through-channel 128 of the sealing piston 122 substantially loss-free, or at least with low losses, into the fluid through-channel 208 of the tool connection piece 128 and from there onwards into the fluid through-channel 212 of the operating part 207 of the tool 196.

If fluid should arrive in the region of the connection chamber 140 located below the sealing piston 122 before the full sealing action comes into effect or during operation of the tool 196 at the sealing faces 138, 222, this fluid can escape to the outside through radial through-holes 226 provided in the connecting section 144 of the holding claw 142, so no counter-pressure can build up in the connection chamber 140 which would reduce the pressing force with which the sealing piston 122 is pressed against the sealing section 200 of the tool connection piece 198.

In order to remove the tool connection piece 198 from the holder 100 again once the fluid feed line 225 has been closed again, the relief nut 180 is screwed further onto the external thread 176 of the guide section 150 of the holding claw 142 and therefore moved upwardly in the axial direction, so the sealing piston 122 is lifted from the sealing section 200 of the tool connection piece 198 by the ring 182 and the spacer pins 184.

Once the sealing piston 122 has thus been moved back from the working position into the rest position, the tool connection piece 198 can be moved upwardly in the axial direction, so the anti-rotation section 216 enters the receiving chamber 172 from the tool insertion channel 174. In the receiving chamber 172, the anti-rotation section 216, and therefore the tool connection piece 198, can be turned back by 90° about its longitudinal axis 201 into the insertion or implementing position (see FIG. 4) in which the flat delimiting faces 218 of the contact section 214 are oriented parallel to the tool insertion channel 174.

The tool connection piece 198 can then be moved in the axial direction out of the holding claw 142.

The conical design of the sealing section 200 of the tool connection piece 198 ensures that the tool connection piece 198 can be easily detached from the sealing piston 122 if it is to be permanently deformed on introduction or during operation of the tool 196.

For easy detachment of the tool connection piece 198 from the sealing piston 122, it is also advantageous for the first cylindrical section 202 of the tool connection piece 198 to have a somewhat smaller external diameter than the second cylindrical section 204.

1. A holder for a tool to be fed with a fluid, the tool comprising a connection piece, the holder comprising a receiver for receiving the connection piece, a sealing element which abuts the connection piece in a sealing element working position, and a biasing device for biasing the sealing element against the connection piece in the sealing element working position.

2. The holder according to claim 1, wherein the receiver is designed in such a way that the connection piece is secured in the sealing element working position against moving out of the holder.

3. The holder according to claim 1, wherein the connection piece comprises a longitudinal axis, and the receiver is designed in such a way that the connection piece is secured in the sealing element working position against rotation of the connection piece about its longitudinal axis relative to the holder.

4. The holder according to claim 1, wherein the biasing device comprises a spring element.

5. The holder according to claim 1, wherein the sealing element is displaceably guided in the holder.

6. The holder according to claim 1, wherein the sealing element has a sealing face which abuts a sealing face of the connection piece in the sealing element working position.

7. The holder according to claim 6, wherein the sealing face of the sealing element is substantially truncated cone-shaped in design.

8. The holder according to claim 7, wherein the sealing face of the sealing element has a cone aperture angle of about 40° to about 80°.

9. The holder according to claim 1, wherein the sealing element comprises a fluid through-channel, through which the fluid fed to the tool can flow.

10. The holder according to claim 1, wherein the sealing element comprises a pressure face which can be loaded by the fluid to be fed to the tool.

11. The holder according to claim 10, wherein the connection piece comprises a sealing face and the sealing element comprises a sealing face, the sealing face of the sealing element engaging the sealing face of the connection piece in the sealing element working position, and the biasing device defining a direction of displacement of the sealing element, and wherein a projection of the pressure face of the sealing element onto a plane perpendicular to the direction of displacement of the sealing element is greater than a projection of the sealing face of the sealing element onto a plane perpendicular to the direction of displacement of the sealing element.

12. The holder according to claim 11, wherein the projection of the sealing face of the sealing element is at least twice as great as the projection of the sealing face of the sealing element onto the plane perpendicular to the direction of displacement of the sealing element.

13. The holder according to claim 1, wherein the holder comprises a movement device, said moving device being adapted to move the sealing element from the sealing element working position into a sealing element rest position in which the sealing element does not engage the connection piece.

14. The holder according to claim 13, wherein the movement device comprises a relief nut.

15. The holder according to claim 1, wherein the sealing element can be loaded with a fluid at a pressure of at least 100 bar.

16. A tool to be supplied with a fluid, which tool can be inserted into the receiver of a holder according to claim 1, said tool being adapted to be brought into a tool working position in the holder and adapted to be brought into contact with the sealing element of the holder in the tool working position.

17. The tool according to claim 16, wherein the tool comprises a sealing face, the sealing face of the tool engaging a sealing face of the sealing element of the holder in the tool working position.

18. The tool according to claim 17, wherein the sealing face of the tool is a substantially truncated cone-shape.

19. The tool according to claim 18, wherein the sealing face of the tool has a cone aperture angle of about 40° to about 80°.

20. The tool according to claim 17, wherein the sealing face is arranged on a substantially truncated cone-shaped end region of the tool.

21. The tool according to claim 20, wherein the tool has a first substantially cylindrical section with a first diameter and a second substantially cylindrical section with a second diameter, the first cylindrical section being arranged between the second cylindrical section and the substantially truncated cone-shaped end region of the tool, the second diameter being greater than the first diameter.

22. The tool according to claim 16, wherein the tool comprises a non-rotationally symmetrical collar which prevents a movement of the connection piece of the tool out of the holder in the longitudinal direction of the connection piece when disposed in the tool working position.

23. The tool according to claim 16, wherein the tool comprises a non-rotationally symmetrical collar which prevents a rotation of the connection piece about its longitudinal axis relative to the holder when disposed in the working position.

24. Combination of a tool according to claim 16 and a holder for a tool to be fed with a fluid, said tool comprising a connection piece, the holder comprising a receiver for receiving the connection piece of the tool, a sealing element which abuts the connection piece in the sealing element working position, and a biasing device for biasing the sealing element against the connection piece in the sealing element working position.

25. The holder according to claim 1 wherein the fluid is water.

26. The holder according to claim 7 wherein the sealing element has a cone aperture angle of about 50° to about 70°.

27. The holder according to claim 12 wherein the projection of the sealing face of the sealing element is at least three times as great as the projection of the sealing face of the sealing element onto the plane perpendicular to the direction of displacement of the sealing element.

28. The holder according to claim 15 wherein the sealing element can be loaded with a fluid at a pressure of at least 1000 bar.

29. The tool according to claim 17 wherein the sealing face of the tool has a cone aperture angle of about 50° to about 70°.
